(19) United States
(12) Patent Application Publication
(10) Pub. No.: US 2013/0062493 A1
(43) Pub. Date: Mar. 14, 2013

(54) Cupholder

(71) Applicant: James Crawford, Arlington, TX (US)

(72) Inventor: James Crawford, Arlington, TX (US)

(21) Appl. No.: 13/199,878

(22) Filed: Sep. 13, 2011

(51) Int. Cl. F16M 13/00

(52) U.S. Cl. 248/311.2

(57) ABSTRACT

Cupholder—a plastic ring with two plastic circles attached at equidistant sides of said circle with two plastic arms attached to and protruding from each respective plastic circle to be placed between the bars of carry on or other rolling type luggage to carry a drinking container.

### CROSS REFERENCE TO RELATED APPLICATIONS

Not applicable.

### STATEMENT REGARDING FEDERALLY SPONSORED RESEARCH OR DEVELOPMENT

The rights to this invention are not made under any federally sponsored research and/or development. Federal funds were not used to develop this invention.

### BACKGROUND OF THE INVENTION

The present invention relates to the field of drinking containers. In particular, the present invention relates to the field of travel accessories for drinking containers.

### BRIEF SUMMARY OF THE INVENTION

This cupholder is designed to be installed between the handle bars of roll-type luggage allowing the user to place a drinking cup therein for ease of travel and convenience.

### BRIEF DESCRIPTION OF THE SEVERAL VIEWS OF THE DRAWING

FIG. 1 shows the plastic ring in which the prospective cup may be placed.

FIG. 2 shows the right and left side plastic circle which is attached to the plastic ring in FIG. 1

FIG. 3 shows the right and left side plastic arm attached to the plastic circle (FIG. 2)

FIG. 4 shows the right and left side plastic arm attached to the plastic circle (FIG. 2)

FIG. 5 shows the right and left side metal screw that holds FIG. 1,2,3, and 4 together

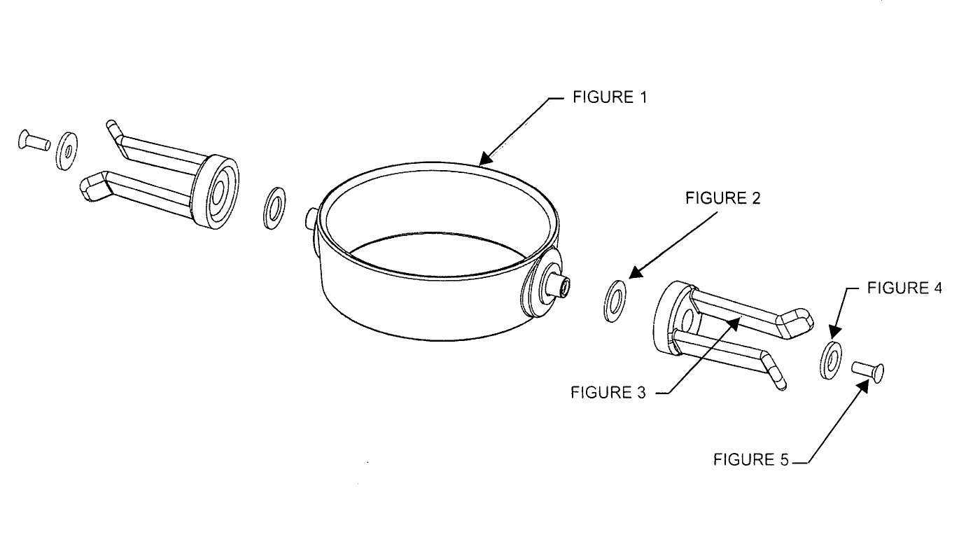

### DETAILED DESCRIPTION OF THE INVENTION

The cupholder is affixed between the two bars of common carry-on and/or rolling luggage and is designed to swing and thus prevent spillage of contents.

Steel molds are prefabricated for each of the cupholder parts. The steel molds are machined out. Melted ABS plastic is injected into each mold. The ABS is left to cool and harden. The component parts are then riveted together with hollow aluminum or steel rivets.

The invention may be embodied in other specific forms without departing from the spirit or essential characteristics thereof. The embodiments disclosed in this application are to be considered in all respects as illustrative and not restrictive, the scope of invention being indicated by the appended claims rather than by the foregoing description, all changes that come within the meaning and range of equivalency of the claims are intended to be embodied herein.

1. An apparatus for holding a drinking container, consisting of:
(a) a plastic ring
(b) a plastic circle attached on opposite, equidistant sides of said plastic ring
(c) two plastic arms attached to and protruding from each said plastic ring
